(19) United States
(12) Patent Application Publication
(10) Pub. No.: US 2025/0124593 A1
(43) Pub. Date: Apr. 17, 2025

(54) CALIBRATION ASSEMBLY FOR TELEPRESENCE VIDEOCONFERENCING SYSTEMS

(71) Applicant: GOOGLE LLC, Mountain View, CA (US)

(72) Inventors: Alejandro Jose Troccoli, San Jose, CA (US); Andrew Block, San Francisco, CA (US); Vineet Vijay Bhatawadekar, Seattle, WA (US); Alexander William Hake, Seattle, WA (US)

(21) Appl. No.: 18/913,671

(22) Filed: Oct. 11, 2024

Related U.S. Application Data
(60) Provisional application No. 63/589,850, filed on Oct. 12, 2023.

(51) Int. Cl. G06T 7/70; H04N 7/15

(52) U.S. Cl. CPC G06T 7/70; H04N 7/15; G06T 2207/10016; G06T 2207/30204; G06T 2207/30244

(57) ABSTRACT

Techniques include a calibration assembly for a telepresence system that includes a stereoscopic display and a set of cameras. The calibration assembly may include at least one chart having chart markers, a mirror having mirror markers, and a processor. An example calibration assembly has three charts and the mirror attached to one of the charts. During calibration, the display is configured to display a set of display markers that are imaged in the mirror. Each camera forms a respective image of the set of chart markers, the set of mirror markers, and the set of display markers. The processing circuitry then determines the poses of the cameras with respect to the display based on the images of the set of chart markers, the set of mirror markers, and the set of display markers.

### CROSS REFERENCE TO RELATED APPLICATION

This application claims the benefit of U.S. Provisional Application No. 63/589,850, filed Oct. 12, 2023, the disclosure of which is incorporated herein by reference in its entirety.

### SUMMARY

Implementations described herein are related to calibrating cameras for accurate reconstruction of a three-dimensional (3D) scene and eye tracking within a stereoscopic 3D display for telepresence videoconferencing. Because stereoscopic 3D displays interleave pixels for left and right eyes, it is desired to have an accurate estimate of a user's eyes with respect to the display pixels. Such an accurate measure of the location of a user's eyes within the display requires measurement of the positions and orientations of the cameras with respect to the display. A calibration assembly for calibrating a telepresence videoconferencing system is configured to determine the positions of the cameras with respect to the display. The calibration assembly includes a set of charts and a mirror. Each of the set of charts has a set of chart markers, e.g., a ChArUco chart, which are ArUco markers arranged in a chessboard pattern. The mirror has at least one mirror marker, e.g., one or more ArUco markers. In some implementations, the mirror is attached to a chart of the set of charts. The mirror forms an image of the display, which displays at least one display marker, e.g., a ChArUco chart. The cameras form images of the set of charts and mirror so that images of the chart markers, mirror markers, and display markers are provided from the perspectives of the cameras. The poses of the cameras with respect to the display may then be determined from the positions of the chart markers, mirror markers, and display markers.

In one general aspect, an apparatus can include at least one chart including a chart marker. The apparatus can also include at least one reflecting surface facing a display, the at least one reflecting surface including a reflecting surface marker, the at least one reflecting surface being configured to form an image of a display marker being displayed in the display. The apparatus can further include a processor coupled to a memory. The processor can be configured to receive a first image of the chart marker, the reflecting surface marker, and the display marker captured with a first camera. The processor can also be configured to receive a second image of the chart marker, the reflecting surface marker, and the display marker captured with a second camera. The processor can further be configured to determine a pose of the first camera with respect to the display and a pose of the second camera with respect to the display based on the first image and the second image.

In another general aspect, a method can include receiving a first image of a chart marker of at least one chart, a display marker displayed in a display, and a reflecting surface marker of at least one reflecting surface configured to form an image of the display marker, the first image being captured with a first camera. The method can also include receiving a second image of the chart marker, the reflecting surface marker, and the display marker captured with a second camera of the telepresence system. The method can further include determining a pose of the first camera with respect to the display and a pose of the second camera with respect to the display based on the first image and the second image.

In another general aspect, a computer program product comprising a nontransitory storage medium, the computer program product including code that, when executed by a processor, causes the processor to perform a method. The method can include receiving a first image of a chart marker of at least one chart, a display marker displayed in a display, and a reflecting surface marker of at least one reflecting surface configured to form an image of the display marker, the first image being captured with a first camera. The method can also include receiving a second image of the chart marker, the reflecting surface marker, and the display marker captured with a second camera of the telepresence system. The method can further include determining a pose of the first camera with respect to the display and a pose of the second camera with respect to the display based on the first image and the second image.

The details of one or more implementations are set forth in the accompanying drawings and the description below. Other features will be apparent from the description and drawings, and from the claims.

### BRIEF DESCRIPTION OF THE DRAWINGS

FIG. 1A is a diagram illustrating a rear view of an example calibration assembly for calibrating a telepresence videoconferencing system in accordance with implementations described herein.

FIG. 1B is a diagram illustrating a front view of the example calibration assembly.

FIG. 2A is a diagram illustrating an example chart of the calibration assembly.

FIG. 2B is a diagram illustrating an example mirror of the calibration assembly.

FIGS. 3A, 3B, and 3C are diagrams that illustrate example images of the chart markers, mirror markers, and display markers from the cameras of the telepresence videoconferencing system.

FIG. 4 is a flow chart illustrating an example process of generating the poses of the cameras with respect to the display based on the images of the chart markers, mirror markers, and display markers.

FIG. 5 is a diagram illustrating an example electronic environment for generating the poses of the cameras with respect to the display based on the images of the chart markers, mirror markers, and display markers.

FIG. 6 is a flow chart illustrating an example method of generating the poses of the cameras with respect to the display.

### DETAILED DESCRIPTION

Telepresence refers to any set of technologies which allow a person to feel as if they were present, at a place other than their true location. Telepresence may involve a user's senses interacting with specific stimuli, e.g., visual, auditory, tactile, olfactory, etc. In applications such as telepresence videoconferencing, just visual and auditory stimuli are considered.

A telepresence videoconferencing system includes a display on which multiple cameras are arranged. The telepresence videoconferencing system is fixed within a room occupied by the user facing the display. The user facing the display sees a fellow participant of a telepresence videoconference. In some implementations, the image on the display seen by the user is configured such that the fellow participant appears to be occupying the room with the user. For example, the cameras may provide images of the user from different perspectives (e.g., angles); such information may be used to provide depth imaging information. Coupling the depth imaging information with texture information may be used to simulate a three-dimensional image of the user in a space occupied by the fellow participant of the telepresence videoconference.

The display may be a stereoscopic three-dimensional (3D) display. Stereoscopic 3D displays present a 3D image to an observer by sending a slightly different perspective view to each of an observer's two eyes, to provide an immersive experience to the observer. The visual system of an observer may process the two perspective images so as to interpret an image containing a perception of depth by invoking binocular stereopsis so the observer can see the image in 3D. Some stereoscopic displays send stereo images to each of a left eye and a right eye of an observer over left and right channels, respectively.

Because of the stereo imagery used to create an interpretation of depth, it is desired to achieve an accurate measure of a user's eyes relative to display coordinates. Such an accurate measure of the location of a user's eyes within the display requires knowledge of the six degrees of freedom (6DoF) pose, i.e., three positional and three orientation coordinates of a camera-display transformation. This knowledge requires careful calibration of the cameras to get the positions of the cameras with respect to the display.

A calibration procedure may be performed in a factory where the telepresence videoconferencing system is assembled. In the calibration procedure, the camera positions with respect to the display are determined. A technical effect of the calibration procedure is that 3D images of a human face are captured with an expected amount of fidelity.

A conventional calibration procedure involves manually setting the positions of the cameras with respect to the display. For example, in a conventional calibration procedure, an operator adjusts the positions of a camera as the cameras are capturing a 3D image of a human face until the 3D image of the human face has been improved.

A technical problem with the conventional calibration procedure is that the conventional calibration procedure is burdensome and error-prone. For example, adjustment of the cameras at the factory can take many minutes, even hours. Such a burdensome calibration procedure is an issue when a series of calibrations need to be made at the factory. Moreover, the 3D image quality based on the resulting conventional calibration may be subpar.

A technical solution to the technical problem involves a calibration assembly for a telepresence system that includes a stereoscopic display and a set of cameras. The calibration assembly may include at least one chart having a set of chart markers, a reflecting surface having a set of reflecting surface markers, and a processor. An example calibration assembly has three charts and a mirror (reflecting surface) attached to one of the charts, e.g., if the charts are arranged in a row, the mirror is attached to the chart in the center. In some implementations, the charts have a ChArUcO pattern, e.g., a chessboard pattern of ArUcO markers. In some implementations, the charts are placed such that each camera of the telepresence system has at least a partial view of at least two of the charts and the mirror.

During calibration, the display is configured to display a set of display markers that are imaged in the mirror. Each camera forms a respective image of the set of chart markers, the set of mirror markers, and the set of display markers. The processing circuitry then determines the poses of the cameras with respect to the display based on the images of the set of chart markers, the set of mirror markers, and the set of display markers.

A technical benefit of the technical solution is that the calibration assembly provides a fast and accurate calibration of a telepresence videoconferencing system. Obtaining such a fast and accurate calibration enables multiple calibrations of such a telepresence videoconferencing system over different environmental conditions such as temperature. Accordingly, having an accurate calibration over different environmental conditions provides a robust experience for a user in the face of changing environmental conditions.

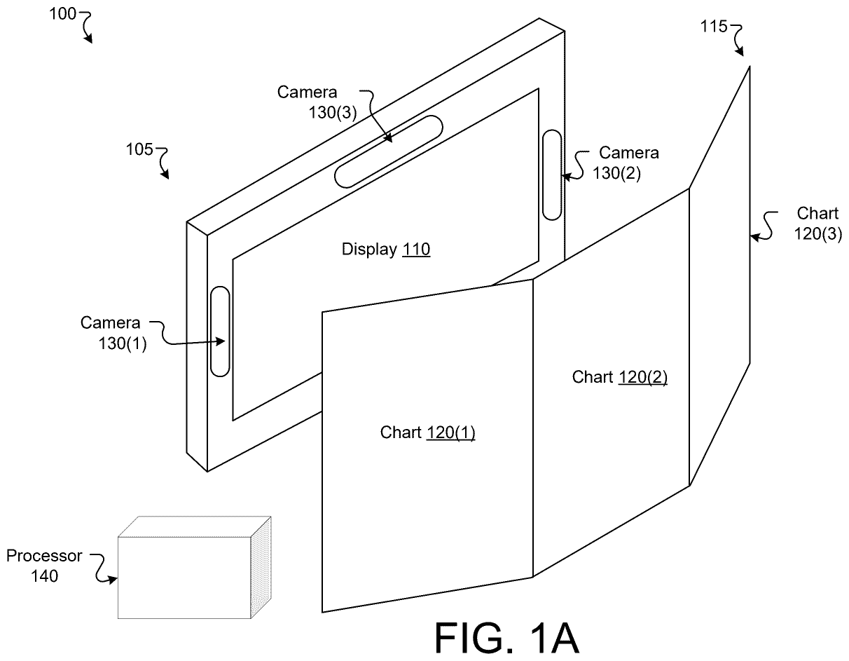

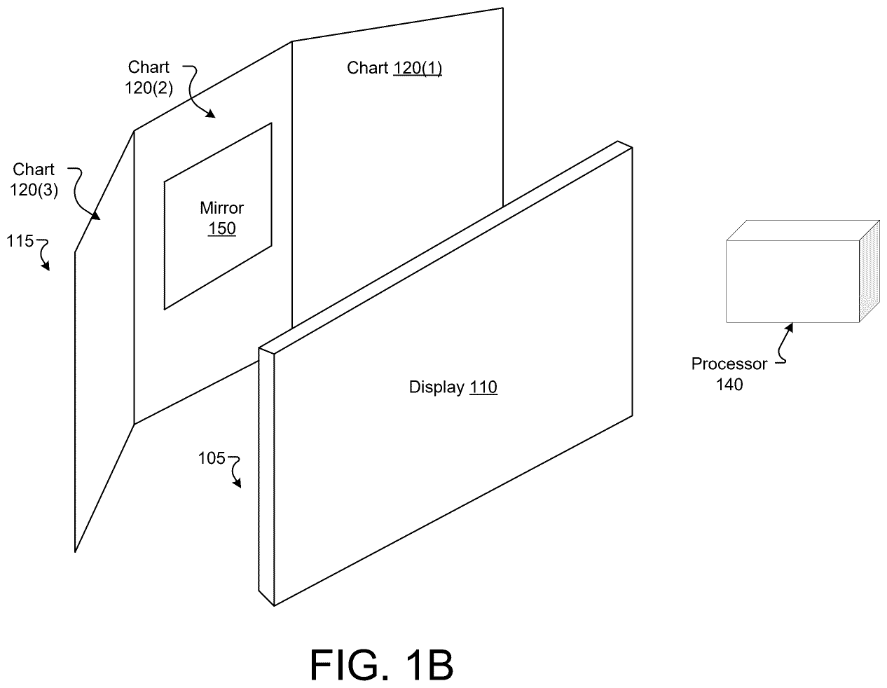

FIG. 1A is a diagram illustrating a rear view of an example calibration assembly 115 for calibrating a telepresence videoconferencing system 105.

As shown in FIG. 1A, the telepresence videoconferencing system 105 includes a display 110 on which three cameras 130(1), 130(2), 130(3) are arranged. The number of cameras is by no means limited to three and can be any number, e.g., two, four, six, eight, etc. The cameras 130(1-3) are not required to be attached to the display 110 as shown in FIG. 1A.

The telepresence videoconferencing system 105 may be fixed within a room occupied by a user facing the display 110. The user facing the display 110 may see a fellow participant of a telepresence videoconference. In some implementations, the image on the display 110 seen by the user is configured such that the fellow participant appears to occupy the room with the user. For example, the cameras 130(1-3) may provide images of the user from different perspectives (e.g., angles); such information may be used to provide depth imaging information. Coupling the depth imaging information with texture information may be used to simulate a three-dimensional image of the user in a space occupied by the fellow participant of the telepresence videoconference.

The display 110 may include a stereoscopic three-dimensional display. Stereoscopic 3D displays present a 3D image to an observer by sending a slightly different perspective view to each of an observer's two eyes, to provide an immersive experience to the observer. The visual system of an observer may process the two perspective images so as to interpret an image containing a perception of depth by invoking binocular stereopsis so the observer can see the image in 3D. Some stereoscopic displays send stereo images to each of a left eye and a right eye of an observer over left and right channels, respectively.

Because of the stereo imagery used to create an interpretation of depth, it is desired to achieve an accurate measure of a user's eyes relative to display coordinates. Such an accurate measure of the location of a user's eyes within the display requires calibration of the poses, e.g., three positional and three orientation coordinates of the cameras 130(1-3) with respect to the display 110.

The calibration assembly 115 is configured to perform the above-described calibration of the positions of the cameras 130(1-3). As shown in FIG. 1A, the calibration assembly 115 includes three charts 120(1), 120(2), 120(3) and processor 140. It is noted that the three charts shown in FIG. 1A is an example of a calibration assembly and a calibration assembly can have any number of charts, e.g., one, two, four, five. Moreover, the number of charts in a calibration assembly does not have to be the same as the number of cameras in a telepresence videoconferencing system.

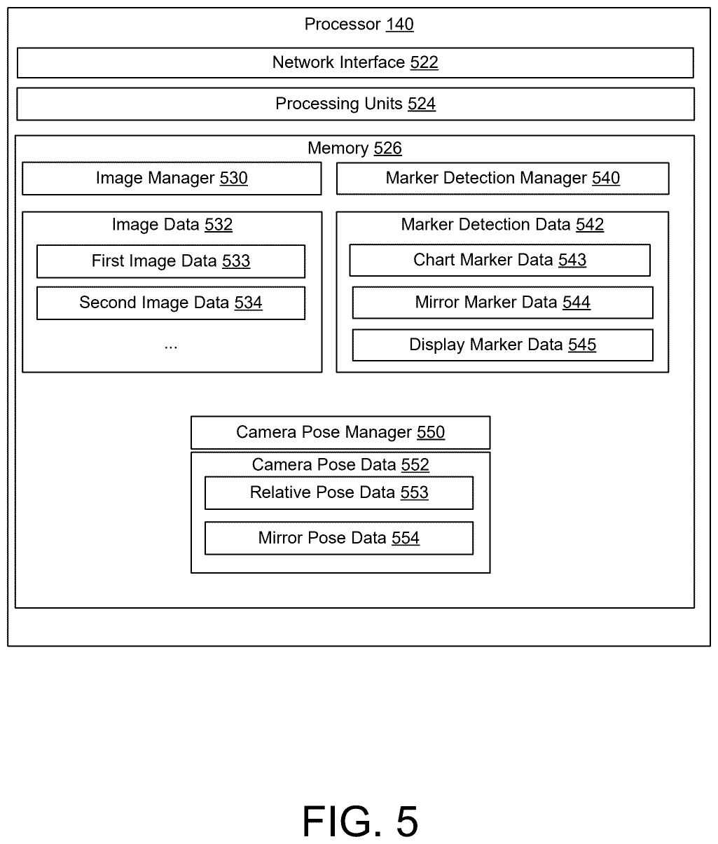

As shown in FIG. 1A, the processor 140 is a device embedded in, e.g., a computer. In some implementations, the processor 140 is embedded in the display 110. The processor 140 is configured to receive images of the markers (e.g., the chart markers, the mirror markers, and the display markers) and determine the poses of the cameras 130(1-3) based on the images. Further detail with regard to processor 140 is discussed with regard to FIG. 5.

Although it is not shown in FIG. 1A, the charts 120(1-3) each have at least one chart marker arranged on the side of charts 120(1-3) facing the cameras 130(1-3). In some implementations, each of the charts 120(1-3) has an arrangement of chart markers. In some implementations, the chart markers are black circular dots of different sizes on a white background. In such an implementation, the circles may be spaced at a known distance from each other (e.g. 5 cm). This prior knowledge on the spacing between circles may provide a known reference for a calibration algorithm.

In some implementations, the chart markers are ArUco markers. An ArUco marker is a synthetic square marker composed by a wide black border and an inner binary matrix which determines its identifier. The black border facilitates its fast detection in the image and the binary codification allows its identification and the application of error detection and correction techniques. The marker size determines the size of the internal matrix. For instance a marker size of 4×4 is composed by 16 bits. It is noted that a marker can be found rotated in the environment; the detection process, however, should be able to determine its original rotation so that each corner may be identified unequivocally. This may also be done based on the binary codification. When the ArUco markers are arranged in a chessboard pattern, the corners of the chessboard squares may be spaced at a known distance. Corners may be easy to detect as regions of high contrast along two dimensions.

As shown in FIG. 1A, the charts 120(1-3) are arranged at angles with respect to one another. For example, the chart 120(1) may be angled at 30 degrees with respect to the chart 130(2), and the chart 120(3) may be angled at 30 degrees with respect to the chart 130(2). In some implementations, the charts 120(1-3) are angled at different angles other than 30 degrees with respect to one another. In some implementations, the charts 120(1-3) are not angled with respect to one another. In some implementations, the plane of the chart 120(2) is substantially parallel with the plane of the display 110.

The calibration assembly 115 is maintained at a fixed distance from the display 110. In some arrangements, when the chart 120(2) is substantially parallel with the plane of the display 110, the chart 120(2) is held about one meter from the display 110. In this way, the chart markers are at distances from the cameras 130(1-3) such that the display markers are kept in focus while being as close to a user position as possible. Accordingly, the poses of the cameras determined via the calibration assembly 115 will be appropriate for such a typical user.

The calibration assembly 115 also has a mirror, which is not shown in FIG. 1A because of the perspective in which the calibration assembly 115 is illustrated. The mirror, however, is shown in FIG. 1B.

FIG. 1B is a diagram illustrating a front view of the example calibration assembly 115 and the telepresence videoconferencing system 105.

As shown in FIG. 1B, in addition to the charts 120(1-3) and processor 140, the calibration assembly 115 also includes a mirror 150. As shown in FIG. 1B, the mirror 150 is attached to the chart 120(2). In this way, because the charts 120(1-3) are facing the display 110, the mirror 150 is configured to form an image of the display 110. It is noted that it is not required for the mirror 150 to be attached to the chart 120(2) as shown in FIG. 1B; for example, the mirror 150 can be attached to any of the charts 120(1-3). Moreover, it is not required that the mirror be attached to any of the charts 120(1-3) and can be mounted separately from the charts 120(1-3). The mirror 150, however, should be visible to all of the cameras 130(1-3).

In some implementations, each of the charts 120(1-3) has an arrangement of chart markers. In some implementations, the chart markers are black circular dots of different sizes on a white background. In some implementations, the chart markers are ArUco markers arranged in a chessboard pattern.

As shown in FIG. 1B, the mirror 150 has the shape of a square. The square shape of the mirror 150, however, is not limiting and the mirror 150 can have any shape so long as the mirror 150 is visible to the cameras 130(1-3).

The mirror has a set of mirror markers. In some implementations, when the mirror has the shape of a square, there are four mirror markers placed symmetrically with respect to the center of the square. In some implementations, the four mirror markers are placed in a vicinity of the corners of the square. In some implementations, the mirror markers are ArUco markers.

During the calibration of the poses of the cameras 130(1-3), the display 110 displays a set of display markers. The set of display markers are then imaged in the mirror 150. In an image of the chart markers, the mirror markers, and the display markers, the display markers may appear in different portions of the mirror 150 depending on which camera 130(1-3) captured the image.

In some implementations, the display markers are ArUco markers arranged in a checkerboard pattern. ArUco markers and boards are very useful due to their fast detection and their versatility. However, one of the problems of ArUco markers is that the accuracy of their corner positions is not too high, even after applying subpixel refinement. In contrast, the corners of chessboard patterns can be refined more accurately since each corner is surrounded by two black squares. However, finding a chessboard pattern is not as versatile as finding an ArUco board: it has to be completely visible and occlusions are not permitted. A chessboard arrangement of ArUco markers, or a ChArUco pattern, combines the benefits of these two approaches. The ArUco part is used to interpolate the position of the chessboard corners, so that it has the versatility of marker boards since it allows occlusions or partial views. Moreover, since the interpolated corners belong to a chessboard, they are very accurate in terms of subpixel accuracy.

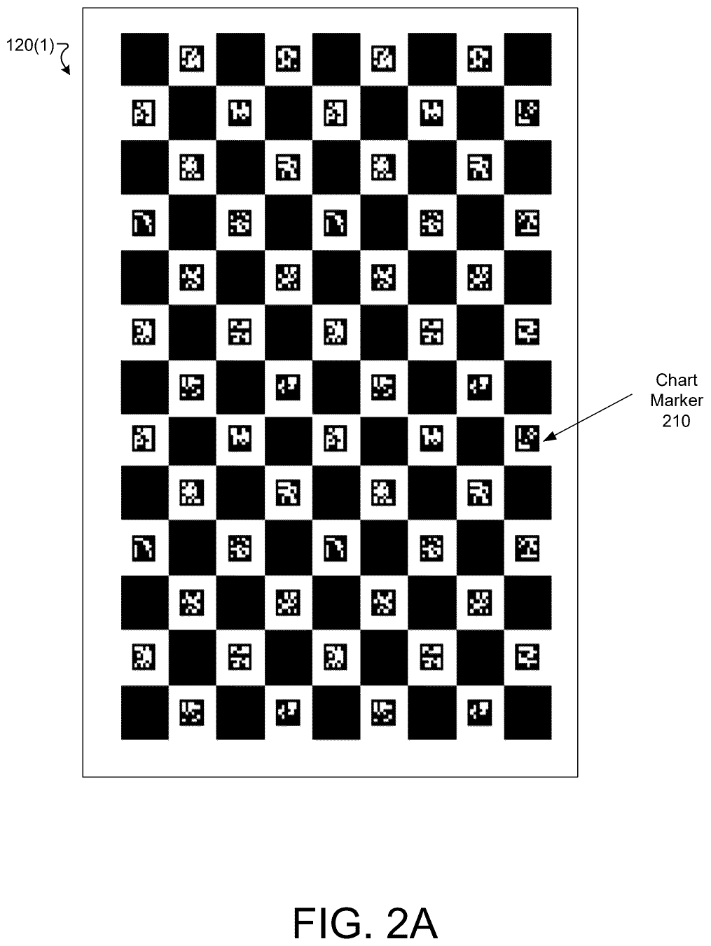

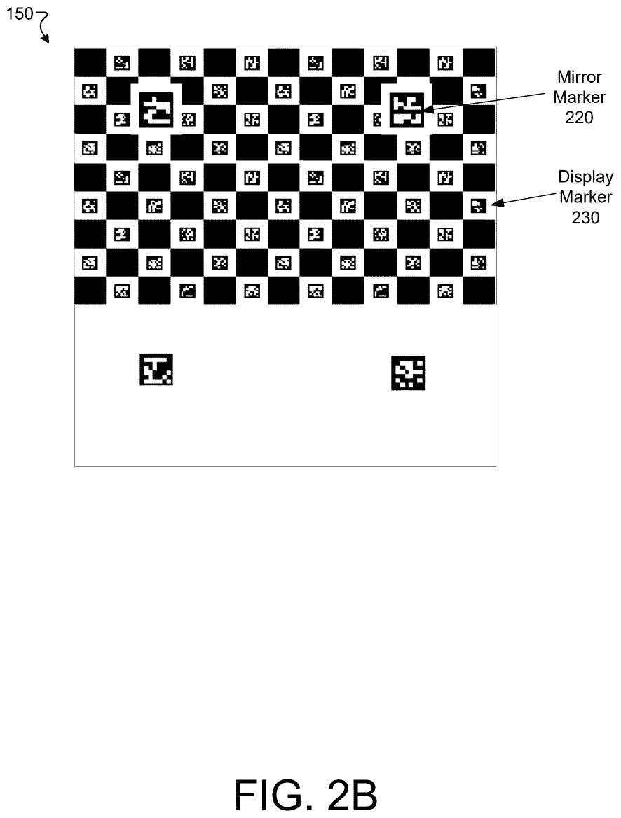

FIG. 2A is a diagram illustrating a layout of the chart 120(1) of the calibration assembly 115. The other charts of the calibration assembly 115, e.g., charts 120(2), 120(3) may have a similar layout as that shown for chart 120(1) in FIG. 2A.

As shown in FIG. 2A, the chart 120(1) has a number of chart markers, including chart marker 210, arranged in a chessboard pattern. In some implementations, the chart markers are ArUco markers. An ArUco marker is a synthetic square marker composed by a wide black border and an inner binary matrix which determines its identifier. The black border facilitates its fast detection in the image and the binary codification allows its identification and the application of error detection and correction techniques. The marker size determines the size of the internal matrix. For example, a marker size of 4×4 is composed by 16 bits. It is noted that a marker can be found rotated in the environment; the detection process, however, should be able to determine its original rotation so that each corner may be identified unequivocally. Such a determination may also be performed based on a binary codification. When the ArUco markers are arranged in a chessboard pattern as shown in FIG. 2A, the corners of the chessboard squares may be spaced at a known distance, e.g., 5 cm. Corners may be easy to detect as regions of high contrast along two dimensions.

As shown in FIG. 2A, the ArUco markers including chart marker 210 are arranged in a chessboard pattern, e.g., a ChArUco pattern. As stated above, a ChArUco pattern combines the benefits of the fast detection and versatility of ArUco markers and the accuracy of the corner positions of a chessboard. The ArUco part is used to interpolate the position of the chessboard corners, so that it has the versatility of marker boards since it allows occlusions or partial views. Moreover, since the interpolated corners belong to a chessboard, they are very accurate in terms of subpixel accuracy.

FIG. 2B is a diagram illustrating the mirror 150 of the calibration assembly 115. As shown in FIG. 2B, the mirror 150 has a set of four mirror markers including mirror marker 220. As described above, the four mirror markers are ArUco markers. The mirror markers are located near the corners of the square mirror 150 so that there is sufficient space between the mirror markers for detection.

In some implementations, the ArUco markers are printed directly on a substrate of the mirror 150 using an ultraviolet (UV) printer. An example of such a UV printer is a Hewlett-Packard (HP) Scitex FB550, supporting 1200×600, 600×600, and 600×300 dots per inch (DPI). In some implementations, the substrate is flat down to 1 wavelength per inch, implying less than a 5 nm plane deviation across a 12-in mirror. In some implementations, the mirror is constructed from a semiconductor wafer.

The mirror 150 is configured to image a set of display markers, including display marker 230, that are displayed in the display 110. An image of the set of display markers as viewed from the perspective of one of the cameras 130(1-3), e.g., camera 130(1), is shown in FIG. 2B.

As shown in FIG. 2B, the set of display markers are arranged in a ChArUco pattern. Each ArUco marker of the ChArUco pattern is smaller than a mirror marker, e.g., mirror marker 220. Moreover, at least one of the mirror markers, e.g., mirror marker 220, at least partially obscures some of the set of display markers. It is noted that the mirror 150 at least partially obscures a portion of the chart markers on the chart 120(2).

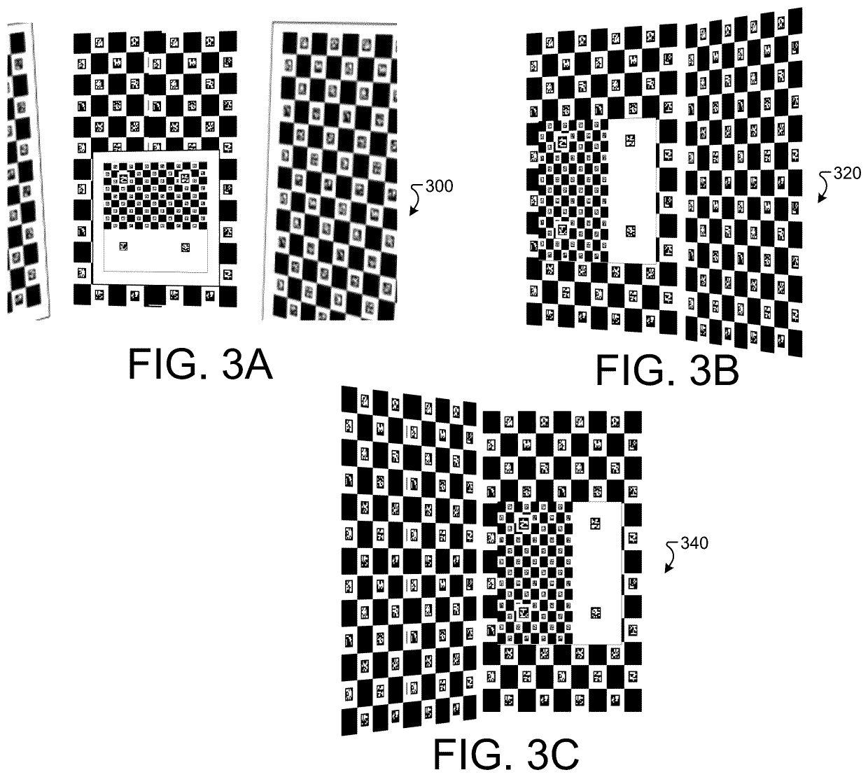

FIGS. 3A, 3B, and 3C are diagrams that illustrate example images 300, 320, and 340 of chart markers, mirror markers, and display markers from cameras (e.g., cameras 130(1-3)) of a telepresence videoconferencing system (e.g., telepresence videoconferencing system 105). For example, the image 300 in FIG. 3A may have been captured with camera 130(1), the image 320 in FIG. 3B may have been captured with camera 130(2), and the image 340 may have been captured with camera 130(3).

The images 300, 320, and 340 show the image of the mirror 150 at least partially obscuring the image of some of the chart markers. The images 300, 320, and 340 also show the image of two of the mirror markers at least partially obscuring the image of some of the display markers. The at least partial obscuration of the chart markers and display markers is alleviated by the fact that the chart markers and display markers are arranged in a ChArUco pattern which allow for such an occlusion.

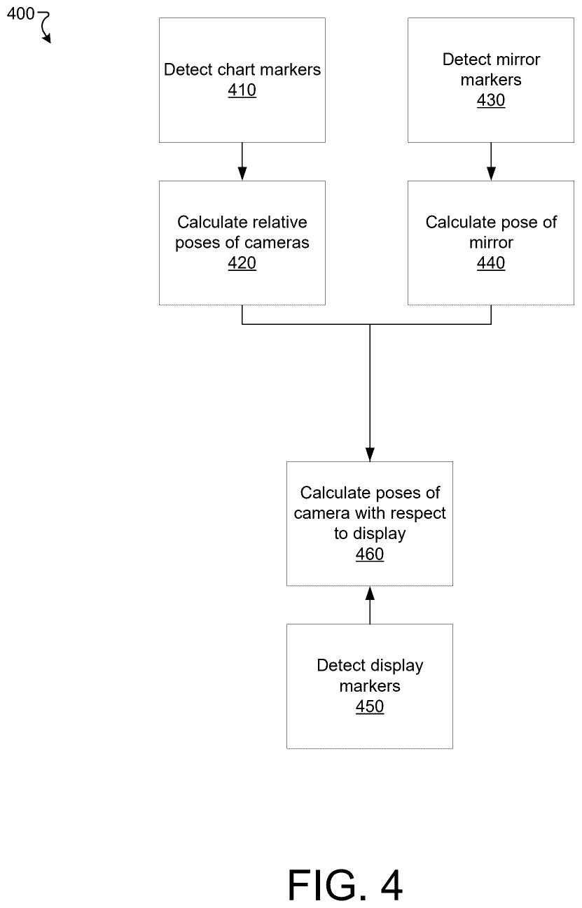

The images 300, 320, and 340 are received by processing circuitry, e.g., processor 140. The processing circuitry then determines the poses of the cameras of the telepresence videoconferencing system 105, e.g., cameras 130(1-3), using the images 300, 320, 340. Details of how the processing circuitry determines the poses of the cameras are presented in FIG. 4.

In some implementations, the images 300, 320, and 340 are captured by the cameras concurrently and synchronously. In some implementations, the images 300, 320, and 340 are captured by the cameras asynchronously.

FIG. 4 is a flow chart illustrating an example process 400 of generating the poses of cameras, e.g., cameras 130(1-3), with respect to a display, e.g., display 110, of a telepresence videoconferencing system, e.g., telepresence videoconferencing system 105, based on the images of the chart markers, mirror markers, and display markers, e.g., images 300, 320, and 340.

As shown in FIG. 4, there are three main processing steps: detection of the visible chart markers 410, detection of the mirror markers 430, and detection of the visible display markers 450 in, e.g., the images 300, 320, and 340. Because the chart markers and display markers are ChArUco patterns, the occlusions of those markers shown in the images 300, 320, and 340 are not problematic. The layout of the ChArUco, e.g., the spacing between the corners of the squares, is a priori known. Accordingly, the detection of the chart markers 410 and the detection of the display markers 450 is straightforward. Because the mirror markers are ArUco markers evenly spaced, the detection of the mirror markers 430 is also straightforward.

As shown in FIG. 4, the detected set of chart markers from 410 may then be used to calculate the relative poses of the cameras with respect to a reference camera 420, e.g., the poses of cameras 130(2) and 130(3) with respect to the pose of camera 130(1). For example, the detected chart markers are first used to generate the poses of the charts, e.g., charts 120(1-3), relative to each of the cameras, e.g., cameras 130(1-3). The processing circuitry then generates a respective visibility matrix for each of the cameras. The processing circuitry then uses each visibility matrix to generate the relative poses of the cameras with respect to the reference camera.

The detected set of mirror markers from 430 may then be used to calculate the pose of the mirror 440. For example, the ArUco mirror markers detected at 430 may be used to generate an equation of a plane of the mirror with respect to the reference camera. From this equation of the plane of the mirror, the processing circuitry generates the location and surface normal of the plane of the mirror.

The detected set of display markers from 450 may then be used to calculate the poses of the cameras with respect to the display 460. For example, the 3D coordinates of the display markers are determined through the detection of the set of display markers from 450. The processing circuitry uses the detected set of display markers and their 3D coordinates, as well as the relative poses of the cameras with respect to the reference camera to determine the poses of the cameras in a frame of the plane of the mirror. The processing circuitry then uses the poses of the cameras in a frame of the plane of the mirror and location and surface normal of the plane of the mirror to determine the poses of the camera with respect to the display, e.g., in the frame of the display.

The calibration of the cameras of the telepresence videoconferencing system as described above may be performed rapidly, e.g., in less than five seconds, likely about three seconds. This makes performing several calibrations over different environmental conditions or values of environmental parameters feasible. This is in contrast to conventional calibration techniques which are more labor-intensive so that such calibration over many different values of an environmental parameter is practically infeasible.

For example, the poses of the cameras can change with temperature. Along these lines, over a 15-minute period of time, the temperature in which the teleconference videoconferencing system operates can go from a cold state (e.g., 50 F) to a warm state (e.g., 72 F). Accordingly, the above-described calibration process may be carried out for a range of temperatures between the cold state and the warm state. The resulting poses of the cameras at each temperature may be recorded in a lookup table. Accordingly, the poses of the cameras of the teleconference videoconferencing system may then be set by processing circuitry according to the lookup table.

FIG. 5 is a diagram that illustrates the processor 140 of configured to determine the poses of cameras of a teleconference videoconferencing system.

The processor 140 includes a network interface 522, one or more processing units 524, and nontransitory memory 526. The network interface 522 includes, for example, Ethernet adaptors, Bluetooth adaptors, and the like, for converting electronic and/or optical signals received from the network to electronic form for use by the processor 140. The set of processing units 524 include one or more processing chips and/or assemblies. The memory 526 is a storage medium and includes both volatile memory (e.g., RAM) and non-volatile memory, such as one or more read only memories (ROMs), disk drives, solid state drives, and the like. The set of processing units 524 and the memory 526 together form part of the processor 140, which is configured to perform various methods and functions as described herein as a computer program product.

In some implementations, one or more of the components of the processor 140 can be, or can include processors (e.g., processing units 524) configured to process instructions stored in the memory 526. Examples of such instructions as depicted in FIG. 5 include an image manager 530, a marker detection manager 540, and a camera pose manager 550. Further, as illustrated in FIG. 5, the memory 526 is configured to store various data, which is described with respect to the respective managers that use such data.

The image manager 530 is configured to cause the processor 140 to receive image data 532 representing a plurality of images captured from a plurality of cameras, including first image data 533 representing a first image captured from a first camera, second image data 534 representing a second image captured from a second camera, and so on. The plurality of images including the first image and the second image are images of chart markers arranged in a ChArUco pattern, display markers arranged in a ChArUco pattern, and four ArUco mirror markers. Each of the plurality of images represents a respective perspective view of the chart markers, mirror markers, and display markers, as shown in FIGS. 3A, 3B, and 3C.

The marker detection manager 540 is configured to cause the processor 140 to generate marker detection data 542 representing 3D positions of the chart markers, mirror markers, and display markers. The marker detection manager 540 generates the marker detection data by performing detection of the ArUco markers in the image data 532. As shown in FIG. 5, the marker detection data 542 includes chart marker data 543, mirror marker data 544, and display marker data 545.

The chart marker data 543 represents the 3D positions of the visible chart markers in the ChArUco pattern. As seen in FIGS. 3A, 3B, and 3C, a portion of the ArUco chart markers are occluded by the mirror. The 3D positions of the visible chart markers, however, are sufficient to determine the relative poses of the cameras.

The mirror marker data 544 represents the 3D positions of the ArUco mirror markers. These ArUco markers may be detected using standard methods because the layout of the ArUco mirror markers is known a priori.

The display marker data 545 represents the 3D positions of the visible display markers in the ChArUco pattern as reflected in the mirror. As seen in FIGS. 3A, 3B, and 3C, a portion of the ArUco display markers are occluded by some of the mirror markers. The 3D positions of the visible display markers, however, are sufficient to determine the relative poses of the cameras because the other positions may be interpolated.

The camera pose manager 550 is configured to cause the processor 140 to generate the camera pose data 552 representing the poses of the cameras with respect to the display based on the marker detection data 542. As shown in FIG. 5, the camera pose data 552 includes relative pose data 553 and mirror pose data 554.

The relative pose data 553 represents a relative pose between each camera and a reference camera, e.g., relative pose between cameras 130(2) and 130(1) and relative pose between cameras 130(3) and 130(1). The camera pose manager 550 generates the relative pose data 553 from the chart marker data 543. For example, the chart marker data 543 are used to generate poses of the charts, e.g., charts 120(1-3), relative to each of the cameras, e.g., cameras 130(1-3). The camera pose manager 550 then generates a respective visibility matrix for each of the cameras. The camera pose manager 550 then uses each visibility matrix to generate the relative poses of the cameras with respect to the reference camera.

The mirror pose data 554 represents a pose of the mirror. For example, the mirror marker data 544 may be used to generate an equation of a plane of the mirror with respect to the reference camera. From this equation of the plane of the mirror, the camera pose manager 550 generates the location and surface normal of the plane of the mirror.

Once the relative pose data 553 and the mirror pose data 554 have been generated, the camera pose manager 550 then generates the camera pose data 552. For example, the 3D coordinates of the display markers are determined through the detection of the set of display markers from 450. The camera pose manager 550 uses the display marker data 545 and the relative pose data 553 to determine the poses of the cameras in a frame of the plane of the mirror. The processor then uses the poses of the cameras in a frame of the plane of the mirror and location and surface normal of the plane of the mirror to determine the poses of the camera with respect to the display, e.g., in the frame of the display.

The components (e.g., modules, processing units 524) of processor 140 can be configured to operate based on one or more platforms (e.g., one or more similar or different platforms) that can include one or more types of hardware, software, firmware, operating systems, runtime libraries, and/or so forth. In some implementations, the components of the processor 140 can be configured to operate within a cluster of devices (e.g., a server farm). In such an implementation, the functionality and processing of the components of the processor 140 can be distributed to several devices of the cluster of devices.

The components of the processor 140 can be, or can include, any type of hardware and/or software configured to process attributes. In some implementations, one or more portions of the components shown in the components of the processor 140 in FIG. 5 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the components of the processor 140 can be, or can include, a software module configured for execution by at least one processor (not shown). In some implementations, the functionality of the components can be included in different modules and/or different components than those shown in FIG. 5, including combining functionality illustrated as two components into a single component.

Although not shown, in some implementations, the components of the processor 140 (or portions thereof) can be configured to operate within, for example, a data center (e.g., a cloud computing environment), a computer system, one or more server/host devices, and/or so forth. In some implementations, the components of the processor 140 (or portions thereof) can be configured to operate within a network. Thus, the components of the processor 140 (or portions thereof) can be configured to function within various types of network environments that can include one or more devices and/or one or more server devices. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can have portions based on various protocols such as Internet Protocol (IP) and/or a proprietary protocol. The network can include at least a portion of the Internet.

In some implementations, one or more of the components of the search system can be, or can include, processors configured to process instructions stored in a memory. For example, image manager 530 (and/or a portion thereof), marker detection manager 540 (and/or a portion thereof), and camera pose manager 550 (and/or a portion thereof) are examples of such instructions.

In some implementations, the memory 526 can be any type of memory such as a random-access memory, a disk drive memory, flash memory, and/or so forth. In some implementations, the memory 526 can be implemented as more than one memory component (e.g., more than one RAM component or disk drive memory) associated with the components of the processor 140. In some implementations, the memory 526 can be a database memory. In some implementations, the memory 526 can be, or can include, a non-local memory. For example, the memory 526 can be, or can include, a memory shared by multiple devices (not shown). In some implementations, the memory 526 can be associated with a server device (not shown) within a network and configured to serve the components of the processor 140. As illustrated in FIG. 5, the memory 326 is configured to store various data, including image data 532 and marker detection data 542.

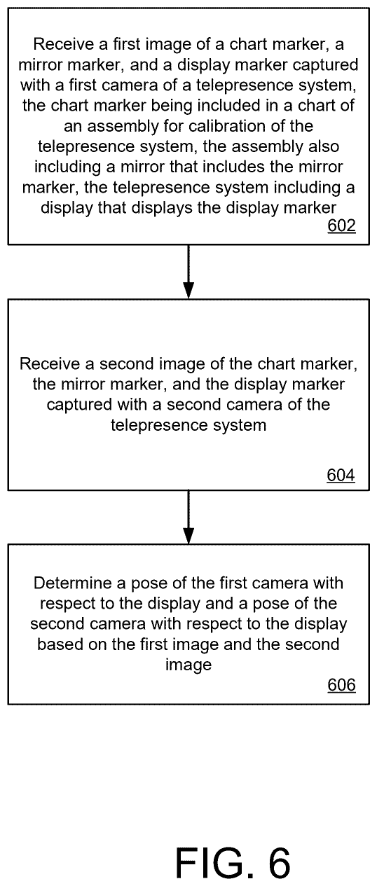

FIG. 6 is a flow chart illustrating a method 600 of determining the poses of cameras of a teleconference videoconferencing system for calibration of the teleconference videoconferencing system. The method 600 may be performed with processor, e.g., processor 140 as shown in FIGS. 1 and 5.

At 602, an image manager (e.g., image manager 530) receives a first image (e.g., 300) of a chart marker (e.g., 210), a mirror marker (e.g., 220), and a display marker (e.g., 230) captured with a first camera (e.g., 130(1)) of a telepresence system (e.g., 105), the chart marker being included in a chart (e.g., 120(2)) of an assembly (e.g., 115) for calibration of the telepresence system, the assembly also including a mirror (e.g., 150) that includes the mirror marker, the telepresence system including a display (e.g., 110) that displays the display marker.

At 604, the image manager receives a second image (e.g., 320) of the chart marker, the mirror marker, and the display marker captured with a second camera (e.g., 130(2)) of the telepresence system.

At 606, a camera pose manager (e.g., camera pose manager 550) determines a position of the first camera with respect to the display and a position of the second camera with respect to the display based on the first image and the second image.

Specific structural and functional details disclosed herein are merely representative for purposes of describing example embodiments. Example embodiments, however, may be embodied in many alternate forms and should not be construed as limited to only the embodiments set forth herein.

The terminology used herein is for the purpose of describing particular embodiments only and is not intended to be limiting of the embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. As used herein the term “and/or” includes any and all combinations of one or more of the associated listed items.

Spatially relative terms, such as “beneath,” “below,” “lower,” “above,” “upper,” and the like, may be used herein for ease of description to describe one element or feature in relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 70 degrees or at other orientations) and the spatially relative descriptors used herein may be interpreted accordingly.

Example embodiments of the concepts are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments of the described concepts should not be construed as limited to the particular shapes of regions illustrated herein but are to include deviations in shapes that result, for example, from manufacturing. Accordingly, the regions illustrated in the figures are schematic in nature and their shapes are not intended to illustrate the actual shape of a region of a device and are not intended to limit the scope of example embodiments.

It will be understood that although the terms “first,” “second,” etc. may be used herein to describe various elements, these elements should not be limited by these terms. These terms are only used to distinguish one element from another. Thus, a “first” element could be termed a “second” element without departing from the teachings of the present embodiments.

Unless otherwise defined, the terms (including technical and scientific terms) used herein have the same meaning as commonly understood by one of ordinary skill in the art to which these concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

While certain features of the described implementations have been illustrated as described herein, many modifications, substitutions, changes, and equivalents will now occur to those skilled in the art. It is, therefore, to be understood that the appended claims are intended to cover such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described.

What is claimed is:

1. An apparatus, including:
at least one chart including a chart marker;
at least one reflecting surface facing a display, the at least one reflecting surface including a reflecting surface marker, the at least one reflecting surface being configured to form an image of a display marker being displayed in the display; and
a processor configured to:
receive a first image of the chart marker, the reflecting surface marker, and the display marker captured with a first camera;
receive a second image of the chart marker, the reflecting surface marker, and the display marker captured with a second camera; and
determine a pose of the first camera with respect to the display and a pose of the second camera with respect to the display based on the first image and the second image.

2. The apparatus as in claim 1, wherein the at least one reflecting surface is attached to the at least one chart.

3. The apparatus as in claim 1, wherein the at least one reflecting surface has a shape of a square.

4. The apparatus as in claim 3, wherein the reflecting surface marker is one of four reflecting surface markers symmetrically placed around the square.

5. The apparatus as in claim 1, wherein the chart marker is an ArUco marker and the display marker is an ArUco marker.

6. The apparatus as in claim 5, wherein the chart marker is included in a first chessboard arrangement of ArUco markers and the display marker is included in a second chessboard arrangement of ArUco markers.

7. The apparatus as in claim 6, wherein the image of the chart marker, the reflecting surface marker, and the display marker includes an image of at least a portion of the first chessboard arrangement of ArUco markers and an image of at least a portion of the second chessboard arrangement of ArUco markers.

8. The apparatus as in claim 1, wherein the processor configured to determine the pose of the first camera with respect to the display and the pose of the second camera with respect to the display is further configured to:
determine a first position of the chart marker in the first image with respect to the first camera;
determine a second position of the chart marker in the second image with respect to the second camera; and
generate a relative pose of the second camera with respect to the first camera based on the first position of the chart marker in the first image and the second position of the chart marker in the second image.

9. The apparatus as in claim 8, wherein the processor configured to determine the pose of the first camera with respect to the display and the pose of the second camera with respect to the display is further configured to:
determine a first position of the reflecting surface marker in the first image with respect to the first camera;
determine a second position of the reflecting surface marker in the second image with respect to the second camera; and
determine a pose of the at least one reflecting surface based on the first position of the reflecting surface marker in the first image and the second position of the reflecting surface marker in the second image.

10. The apparatus as in claim 9, wherein the processor configured to determine the pose of the first camera with respect to the display and the pose of the second camera with respect to the display is further configured to:
calculate the pose of the first camera with respect to the display and the pose of the second camera with respect to the display based on the relative pose of the second camera with respect to the first camera and the pose of the at least one reflecting surface.

11. The apparatus as in claim 1, wherein the first image is captured with the first camera and the second image is captured with the second camera when a parameter has a first value, wherein the pose of the first camera with respect to the display is a first pose of the first camera with respect to the display when the parameter has the first value, and wherein the pose of the second camera with respect to the display is a first pose of the second camera with respect to the display when the parameter has the first value;
wherein the processor is further configured to:
receive a third image of the chart marker, the reflecting surface marker, and the display marker captured with the first camera at a second value of the parameter;
receive a fourth image of the chart marker, the reflecting surface marker, and the display marker captured with the second camera at the second value of the parameter;
determine a second pose of the first camera with respect to the display and a second position of the second camera with respect to the display based on the third image and the fourth image; and
generate a lookup table based on the first pose of the first camera with respect to the display and the first pose of the second camera with respect to the display at the first value of the parameter and the second pose of the first camera with respect to the display and the second pose of the second camera with respect to the display at the second value of the parameter.

12. The apparatus as in claim 11, wherein the parameter is temperature of an environment in which the first camera and the second camera are maintained.

13. A method, comprising:
receiving a first image of a chart marker of at least one chart, a display marker displayed in a display, and a reflecting surface marker of at least one reflecting surface configured to form an image of the display marker, the first image being captured with a first camera;
receiving a second image of the chart marker, the reflecting surface marker, and the display marker captured with a second camera; and
determining a pose of the first camera with respect to the display and a pose of the second camera with respect to the display based on the first image and the second image.

14. The method as in claim 13, wherein the chart marker is an ArUco marker and the display marker is an ArUco marker.

15. The method as in claim 14, wherein the chart marker is included in a first chessboard arrangement of ArUco markers and the display marker is included in a second chessboard arrangement of ArUco markers.

16. The method as in claim 15, wherein the image of the chart marker, the reflecting surface marker, and the display marker includes an image of at least a portion of the first chessboard arrangement of ArUco markers and an image of at least a portion of the second chessboard arrangement of ArUco markers.

17. The method as in claim 13, wherein determining the pose of the first camera with respect to the display and the pose of the second camera with respect to the display includes:
determining a first position of the chart marker in the first image with respect to the first camera;
determining a second position of the chart marker in the second image with respect to the second camera; and
generating a relative pose of the second camera with respect to the first camera based on the first position of the chart marker in the first image and the second position of the chart marker in the second image.

18. The method as in claim 17, wherein determining the pose of the first camera with respect to the display and the pose of the second camera with respect to the display further includes:
determining a first position of the reflecting surface marker in the first image with respect to the first camera;
determining a second position of the reflecting surface marker in the second image with respect to the second camera; and
determining a pose of the at least one reflecting surface based on the first position of the reflecting surface marker in the first image and the second position of the reflecting surface marker in the second image.

19. The method as in claim 18, wherein determining the pose of the first camera with respect to the display and the pose of the second camera with respect to the display further includes:
calculating the pose of the first camera with respect to the display and the pose of the second camera with respect to the display based on the relative pose of the second camera with respect to the first camera and the pose of the at least one reflecting surface.

20. A computer program product comprising a nontransitory storage medium, the computer program product including code that, when executed by a processor, causes the processor to perform a method, the method comprising:
receiving a first image of a chart marker of at least one chart, a display marker displayed in a display, and a reflecting surface marker of at least one reflecting surface configured to form an image of the display marker, the first image being captured with a first camera;
receiving a second image of the chart marker, the reflecting surface marker, and the display marker, the second image being captured with a second camera; and
determining a pose of the first camera with respect to the display and a pose of the second camera with respect to the display based on the first image and the second image.

21. The computer program product as in claim 20, wherein the at least one reflecting surface is attached to the at least one chart.
